(19) United States
(12) Patent Application Publication
(10) Pub. No.: US 2019/0100460 A1
(43) Pub. Date: Apr. 4, 2019

(54) COMPOSITIONS AND METHODS FOR RECYCLING DRILL CUTTINGS INTO ROADWAY MATERIALS

(71) Applicants: Billy Shane McDade, Austin, TX (US); Jason Cogburn, Eastland, TX (US); Gary Porritt, South Jordan, UT (US)

(72) Inventors: Billy Shane McDade, Austin, TX (US); Jason Cogburn, Eastland, TX (US); Gary Porritt, South Jordan, UT (US)

(21) Appl. No.: 16/148,284

(22) Filed: Oct. 1, 2018

Related U.S. Application Data
(60) Provisional application No. 62/567,883, filed on Oct. 4, 2017.

(51) Int. Cl. C04B 18/04

(52) U.S. Cl. CPC C04B 18/049

(57) ABSTRACT

Embodiments can include use of at least one additive to process or condition drill cuttings. The drill cuttings may be further used as a product, a component of a product, and/or in another process. For example, the drill cuttings may be used as aggregate for roadway material (e.g., asphalt stabilized material, asphalt cement concrete, etc.). The conditioning can include modifying a mechanical property of the roadway material, modifying the ability to encapsulate toxins within the asphalt so as to prevent or inhibit leaching of toxins, modifying the ability to absorb volatile hydrocarbon fractions to as to improve stability of the roadway material, etc.

### CROSS-REFERENCE TO RELATED APPLICATIONS

This patent application relates to and claims the benefit of priority to U.S. Provisional Application Ser. No. 62/567,883 filed on Oct. 4, 2017, the entire contents of which is incorporated herein by reference.

### FIELD OF THE INVENTION

Embodiments can relate to compositions and methods for processing material that may be used for roadways.

### BACKGROUND OF THE INVENTION

“Drill Cuttings” are waste material produced by the action of drilling holes in the earth for purposes of extracting crude oil and natural gas. Drill cuttings are typically comprised of different types of rock encountered by the drilling apparatus that exist between the soil layer and the oil/gas deposit. During the process of oil/gas extraction, large amounts of these cuttings are produced, depending on the number of wells that are drilled to extract the oil/gas. With the advent of hydrolic fracturing (“fracing”) and directional drilling, the amount of cuttings produced by the industry has increased. The drill cuttings typically have the consistency of moist to wet soil, as the process of drilling grinds them into small particles and uses additives that “wetten” the material.

Generally, the drill cuttings are disposed of. Accepted methods of disposal can vary from state to state and country to country, with many jurisdictions allowing burial or spreading of the cuttings. However, the drill cuttings are typically contaminated with various environmentally hazardous materials, either naturally occurring or because of chemicals used in the drilling process. The drill cuttings containing contaminates lead most jurisdictions to regulate the disposal process, which usually involves hauling them to a centralized facility that accepts the drill cuttings for disposal in a controlled environment. This can include incinerating the drill cuttings or burying them in a lined pit to prevent leaching of the hazard materials. The costs associated with such incineration and disposal methods can be high.

### BRIEF SUMMARY OF THE INVENTION

Embodiments of the disclosed method can remediate or condition the drill cuttings to allow for more efficient, cost-effective processing of the drill cuttings. This can facilitate the disposal of the drill cuttings in a more efficient, cost-effective manner. Some embodiments can remediate or condition the drill cuttings to facilitate use of the drill cuttings for other useful applications.

For example, embodiments of the method can involve use of at least one additive to condition drill cuttings. The conditioned drill cuttings may be further used as a product, a component of a product, and/or in another process. For example, the conditioned drill cuttings may be used as aggregate for roadway material. Roadway material can include asphalt stabilized base material, asphalt cement concrete, etc. In some embodiments, the asphalt stabilized base material can be used as roadway material and/or be used as part of asphalt cement concrete. The conditioning can include modifying a mechanical property of the roadway material, modifying the ability to encapsulate toxins within the roadway material so as to prevent or inhibit leaching of the toxins, modifying the ability to absorb volatile hydrocarbon fractions so as to improve stability of the roadway material, etc.

In one embodiment, a conditioned material can include an unconditioned material comprising one or more toxin and/or one or more volatile hydrocarbon fraction. The conditioned material can include a first additive configured to encapsulate the one or more toxin. The conditions material can include a second additive configured to absorb the one or more volatile hydrocarbon fraction.

In some embodiments, the first additive is configured to encapsulate a predetermined amount of the one or more toxin. In some embodiments, the second additive is configured to absorb a predetermined amount of the one or more volatile hydrocarbon fraction. In some embodiments, the encapsulation prevents and/or inhibits leaching of the one or more toxin from the conditioned material to a surrounding environment. In some embodiments, the unconditioned material is drill cuttings. In some embodiments, the conditioned material is roadway material and/or aggregate for the roadway material.

In one embodiment, a roadway material can include aggregate comprising one or more toxin and/or one or more volatile hydrocarbon fraction. The roadway material can include a first additive configured to encapsulate a predetermined amount of the one or more toxin. The roadway material can include a second additive configured to absorb a predetermined amount of the one or more volatile hydrocarbon fraction.

In some embodiments, the aggregate comprises a first aggregate and a second aggregate. In some embodiments, the first aggregate comprises drill cuttings and the second aggregate comprises gravel, sand, crushed or pulverized cement, and/or recycled pavement. In some embodiments, the first additive is further configured to facilitate suspension of a predetermined amount of a globule of asphalt cement. Some embodiments include a third additive configured to reduce the amount of the first additive to achieve the predetermined level of stability for the roadway material. In some embodiments, the roadway material has a Unconfined Compressive Strength of at least 35 pounds per square inch. In some embodiments, the roadway material comprises at least one of arsenic, barium, cadmium, chromium, lead, mercury, selenium, silver, zinc, benzene, chlorides, and/or total petroleum hydrocarbons. In some embodiments, the roadway material has high levels of volatile hydrocarbon fractions.

In one embodiment, a roadway material can include a first aggregate comprising one or more toxin and one or more volatile hydrocarbon fraction. The roadway material can include a second aggregate comprising roadway material. The roadway material can include a first additive configured to encapsulate a predetermined amount of the one or more toxin and to facilitate suspension of a predetermined amount of a globule of asphalt cement. The roadway material can include a second additive configured to reduce the amount of the first additive to achieve the predetermined level of stability for the roadway material.

Some embodiments can include a third additive configured to absorb a predetermined amount of the one or more volatile hydrocarbon fraction. In some embodiments, the roadway material comprises: 0% to 100% first aggregate; 0% to 100% second aggregate; above 0.0% to 5.0% first additive, wherein the percent is a weight percent of the mixture of first aggregate and second aggregate; and above 0.0% to 20.0% second additive, wherein the percent is a weight percent of the mixture of first aggregate and second aggregate.

In some embodiments, the roadway material comprises: 0% to 100% first aggregate; 0% to 100% second aggregate; above 0.0% to 5.0% first additive, wherein the percent is a weight percent of the mixture of first aggregate and second aggregate; above 0.0% to 20.0% second additive, wherein the percent is a weight percent of the mixture of first aggregate and second aggregate; and above 0.00% to 20.0% third additive, wherein the percent is a weight percent of the mixture of first aggregate and second aggregate.

In some embodiments, the roadway material has a Unconfined Compressive Strength of at least 35 pounds per square inch. In some embodiments, the roadway material comprises at least one of arsenic, barium, cadmium, chromium, lead, mercury, selenium, silver, zinc, benzene, chlorides, and total petroleum hydrocarbons. In some embodiments, the roadway material has high levels of volatile hydrocarbon fractions.

In one embodiment, a method of processing drill cuttings can involve adding an additive to the drill cuttings to at least one of: encapsulate a predetermined amount of one or more toxin that is part of the drill cuttings; and absorb a predetermined amount of one or more volatile hydrocarbon fraction that is part of the drill cuttings.

Further features, aspects, objects, advantages, and possible applications of the present invention will become apparent from a study of the exemplary embodiments and examples described below, in combination with the Figures, and the appended claims.

### BRIEF DESCRIPTION OF THE FIGURES

The above and other objects, aspects, features, advantages and possible applications of the present invention will be more apparent from the following more particular description thereof, presented in conjunction with the following drawings, in which:

FIG. 1 shows a flow diagram of an embodiment of the method that can be used for processing an unconditioned material into a conditioned material.

FIG. 2 shows a flow diagram of an embodiment of the method that can be used for processing drill cuttings to facilitate use of them as a component of asphalt stabilized base material.

FIG. 3 is a block diagram of various effects embodiments of an emulsion agent may have on an embodiment of asphalt stabilized road base material.

FIG. 4 is a block diagram of various effects embodiments of a maltene agent may have on an embodiment of asphalt stabilized base material.

FIG. 5 is a block diagram of various effects embodiments of an asphaltene agent may have on an embodiment of asphalt stabilized base material.

FIGS. 6-9 show environmental test results of various samples, demonstrating acceptable leaching levels.

### DETAILED DESCRIPTION OF THE INVENTION

The following description is of an embodiment presently contemplated for carrying out the present invention. This description is not to be taken in a limiting sense, but is made merely for the purpose of describing the general principles and features of the present invention. The scope of the present invention should be determined with reference to the claims.

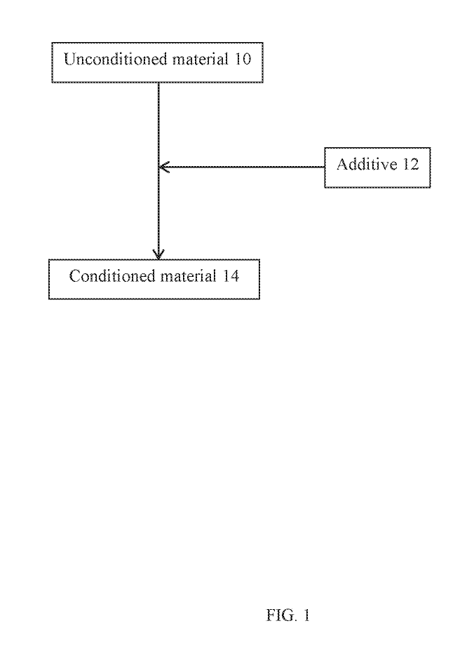

Referring to FIG. 1, embodiments can include a method for processing an unconditioned material 10 to generate a conditioned material 14. For example, embodiments of the method can involve processing an unconditioned material 10 so that the resultant conditioned material 14 exhibits desired properties or range of properties. The desired properties or range of properties may make the conditioned material 14 useful for certain applications, which can include allowing the conditioned material 14 useful as a component of a product. For instance, embodiments of the method can involve processing drill cuttings (e.g., unconditioned material) into aggregate (e.g., conditioned material) of asphalt stabilized base material (e.g., product) that may be suitable for roadway construction. In some embodiments, the conditioned material 14 can be the product. The conditioning may be modifying a mechanical property of the asphalt cement, modifying the ability to encapsulate toxins within the asphalt stabilized base material so as to prevent or inhibit leaching of the toxins, modifying the ability to absorb volatile hydrocarbon fractions, etc.

Generally, the unconditioned material 10 can include by-product (e.g., incidental or secondary product made in the manufacture or synthesis of something else), waste product (e.g., material or substance that can be viewed as generally unusable or unwanted), and/or scrap material (e.g., leftover pieces, swarf, etc.). Examples of unconditioned material 10 can include drill cuttings, slag, sludge, etc. While various embodiments disclosed herein may describe the unconditioned material 10 as drill cuttings, it is understood that other materials can be used.

The conditioned material 14 can be the product, a substance that is a component to the product, a substance that is useful in another process, etc. For instance, the conditioned material 14 can be at least a portion of aggregate for roadway material. As used herein, roadway material can refer to asphalt stabilized base material, asphalt cement concrete, etc. For example, in some embodiments, the conditioned material 14 can be used as aggregate for asphalt stabilized base material, which may be used as roadway material. In some embodiments, the conditioned material 14 can be used as aggregate for asphalt stabilized base material, which may be used as part of asphalt cement concrete. The asphalt cement concrete can then be used as roadway material. While various embodiments disclosed herein may describe the product to be asphalt stabilized base material and the conditioned material 14 as at least a portion of aggregate for the asphalt stabilized base material, other conditioned materials 14 and products can include roofing material (e.g., shingles), coating (e.g., waterproofing), other structural surfaces or supports, etc.

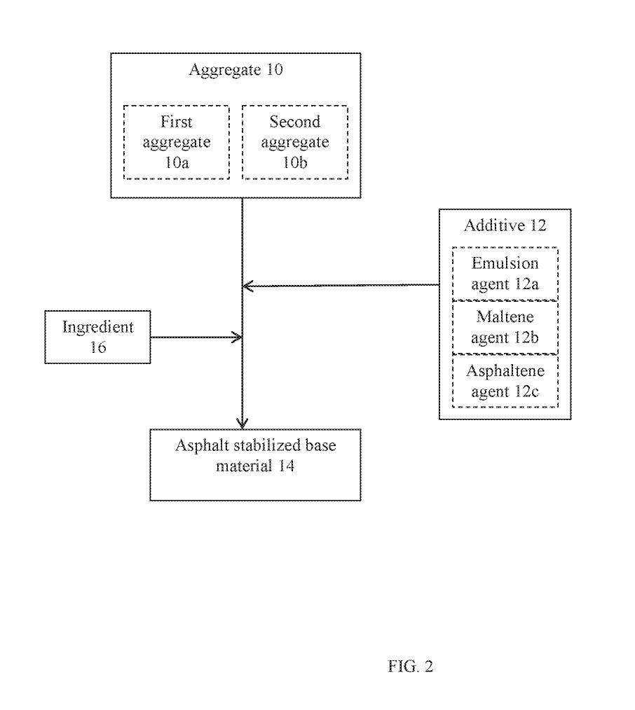

Referring to FIG. 2, a non-limiting, exemplary embodiment may involve processing drill cuttings 10a into aggregate 10 for asphalt stabilized material 14. Some embodiments can include the addition of other aggregate. For example, the aggregate can include a first aggregate 10a (e.g., the processed drill cuttings) and a second aggregate 10b. The second aggregate 10b can include gravel, sand, crushed or pulverized cement, recycled pavement, etc. The second aggregate 10b may also include virgin base materials (e.g., crushed aggregate base), in situ road components (e.g., base materials and asphalt concrete pavement), and/or previously reclaimed roadway materials (e.g., reclaimed asphalt pavements (“RAP”)).

Embodiments of method can involve processing any one or combination of the drill cuttings 10a, the aggregate 10, and/or the asphalt stabilized material 14. The processing can be done to change and/or control the material properties of the drill cuttings 10a, the aggregate 10, and/or the asphalt stabilized material 14. The processing can involve the use of at least one additive 12. Any one or combination of the drill cuttings 10a, the aggregate 10, and/or the asphalt stabilized material 14 can be mixed, combined, and/or placed into solution with the additive 12. The additive 12 can include any one or combination of an emulsion agent 12a, a maltene agent 12b, and an asphaltene agent 12c. Use of the additive 12 can generate aggregate 10 and/or asphalt stabilized material 14 that is configured to encapsulate a certain compound so as to prevent or inhibit leaching of the encapsulated compound. In addition, or in the alternative, the additive 12 can generate aggregate 10 and/or asphalt stabilized material 14 having a desired mechanical property (e.g., have a predetermined Unconfined Compressive Strength (“UCS”)) that allows the asphalt stabilized material 14 to be used for a desired application (e.g., as pavement, a sidewalk, a roadway base material, etc.). UCS can be defined as the ratio of failure load to the cross sectional area of a sample being tested. UCS can be measured in pounds per square inch (“psi”).

### Examples of Emulsion Agents

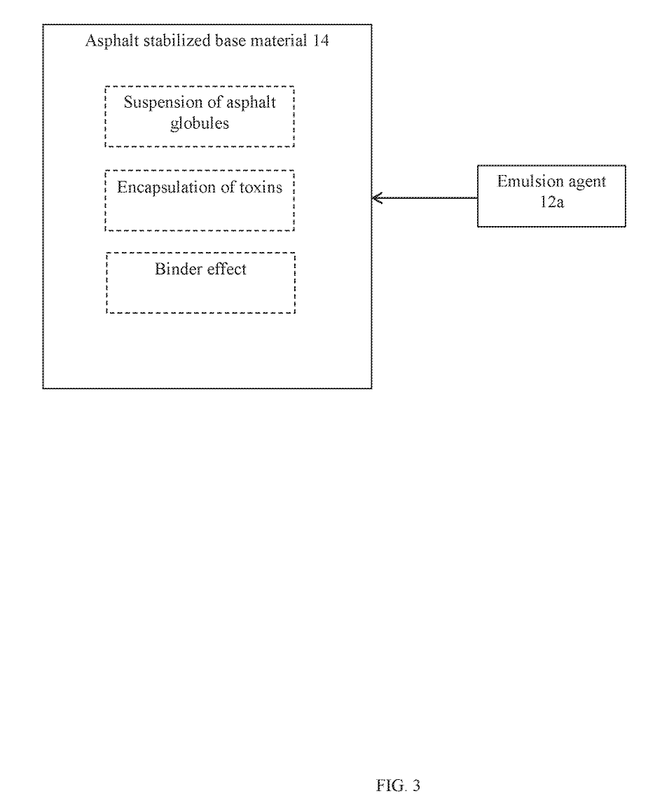

Referring to FIG. 3, embodiments of the emulsion agent 12a can be a surfactant. Embodiments of the emulsion agent 12a can include any one or combination of anionic, cationic, and/or nonionic emulsion agents. Embodiments of the emulsion agent 12a can be any one or combination of a quick set emulsion agent (designated by “QS”), a rapid set emulsion agent (designated by “RS”), a medium set emulsion agent (designated by “MS”), and a slow set emulsion agent (designated by “SS”). The designations may be used to identify how quickly the emulsion coalesces or reverts to asphalt stabilized material 14. Examples of emulsion agents 12a can include, but are not limited to, CSS-1H, SS-1H, SS-1, and high float emulsion agents (e.g., CHFE-300, FIFE-300, HFE-300P, etc.). The amount of emulsion agent 12a that can be added can include a wide range of weight percents. The amount of emulsion agent 12a added depends upon to composition of the aggregate 10 and the material properties desired for the asphalt stabilized material 14. Thus, monitoring and testing can be performed to the aggregate 10 and/or asphalt stabilized material 14 as the emulsion agent 12a is added to determine the amount and type of emulsion agent 12a needed to generate the desired material properties for the asphalt stabilized material 14. Generally, for stabilized roadway material (e.g., having a UCS equal to or greater than 35 psi), the percent emulsion agent 12a can be within a range from 0.0% to 7.0%.

In some embodiments, the emulsion agent 12a can be configured to facilitate suspension of asphalt cement globules, provided the asphalt cement is included as part of the roadway material. This may be done to prevent or inhibit the asphalt cement globules from coalescing. As an example, embodiments of the emulsion agent 12a can be configured to impart an electrical charge to the asphalt cement globule to facilitate suspension of the globule. Embodiments of the method can involve adding a predetermined amount/concentration and type of an emulsion agent 12a to facilitate suspension of a predetermined amount asphalt cement globules.

In addition, or in the alternative, embodiments of the emulsion agent 12a can be configured to facilitate encapsulation of a compound, element, or mineral. This can involve molecular encapsulation. For example, embodiments of the emulsion agent 12a can be configured to confine a compound molecule inside a cavity of the emulsion molecule. Encapsulation can be used for preventing or inhibiting the compound from leaching out from the drill cuttings 10a, the aggregate 10, and/or the asphalt stabilized material 14. This can include preventing or inhibiting the compound from leaching into the surrounding environment (e.g., surrounding land, waterways, groundwater, etc.). For example, the drill cuttings 10a can include compounds that may leach into the surrounding ground when the drill cuttings 10a are used as part of the asphalt stabilized material 14 or when the drill cuttings 10a are otherwise buried in the ground. Some of the compounds may be considered toxins (e.g., chlorides, heavy metals, hydrocarbons added to the cuttings during the drilling process, etc.). Yet, embodiments of the method can involve use of emulsion agents 12a to encapsulate at least some of the toxins to prevent or inhibit them from leaching into the surrounding ground. The toxins can include arsenic, barium, cadmium, chromium, lead, mercury, selenium, silver, zinc, benzene, chlorides, total petroleum hydrocarbons, etc.

Embodiments of the method can involve adding a predetermined amount/concentration and type of emulsion agent 12a to facilitate encapsulating a predetermined amount/concentration of a toxin. The addition of an emulsion agent 12a can prevent or inhibit a predetermined amount/concentration of the toxin from leaching from the drill cuttings 10a, the aggregate 10, and/or the asphalt stabilized material 14. This can include preventing or inhibiting a predetermined amount/concentration of the toxin from leaching into the surrounding environment. In some embodiments, the use of an emulsion agent 12a can reduce and/or limit the rate at which the toxin leaches from the drill cuttings 10a, the aggregate 10, and/or the asphalt stabilized material 14. This can include reducing and/or limiting the rate at which the toxin leaches into the surrounding environment.

For example, embodiments can generate an asphalt stabilized base material 14 including the toxins and limiting the amount of toxin leeching from the asphalt stabilized base material 14 to the following parameters:

Arsenic<5.00 mg/l
Barium<100.00 mg/l
Cadmium<1.00 mg/l
Chromium<5.00 mg/l
Lead<5.00 mg/l
Mercury<0.20 mg/l
Selenium<1.00 mg/l
Silver<5.00 mg/l
Zinc<5.00 mg/l
Benzene<0.50 mg/l
Chlorides<700.00 mg/l
Total petroleum hydrocarbons<100.00 mg/l

Conventional processing methods are generally limited to removing a predetermined amount of toxins that exist in the drill cuttings and/or incinerating the drill cuttings. Removal of the toxins and/or incinerating the drill cuttings can require complex, expensive, and/or time consuming procedures. Embodiments of the disclosed method, however, can allow the drill cuttings 10a to be used without removing the toxins. For example, embodiments of the method can allow for processing the drill cuttings 10a so that the drill cuttings 10a (along with the toxins) can be placed on and/or into the ground (or other environment) without the toxins leaching into the environment, or at least inhibit the toxins from leaching into the environment. This can include placing the drill cuttings 10a on the ground of a staging or storage site, burying the drill cuttings 10a in a dump site, using the drill cuttings 10a as fill, using the drill cuttings 10a as at least part of aggregate 10 for asphalt stabilized material 14, etc.

In addition, or in the alternative, embodiments of the emulsion agent 12a can be configured to stabilize the asphalt stabilized material 14. This can include configuring the emulsion agent 12a as a binder. Stabilization can include generating an asphalt stabilized material 14 that, when it hardens, binds sufficiently together to form a hard payment with strength that suitable for its intended purpose. The stabilization can be measured by a UCS measurement. Embodiments of the method can involve adding a predetermined amount/concentration and type of emulsion agent 12a to facilitate stabilization of the asphalt stabilized material 14.

### Examples of Maltene Agents

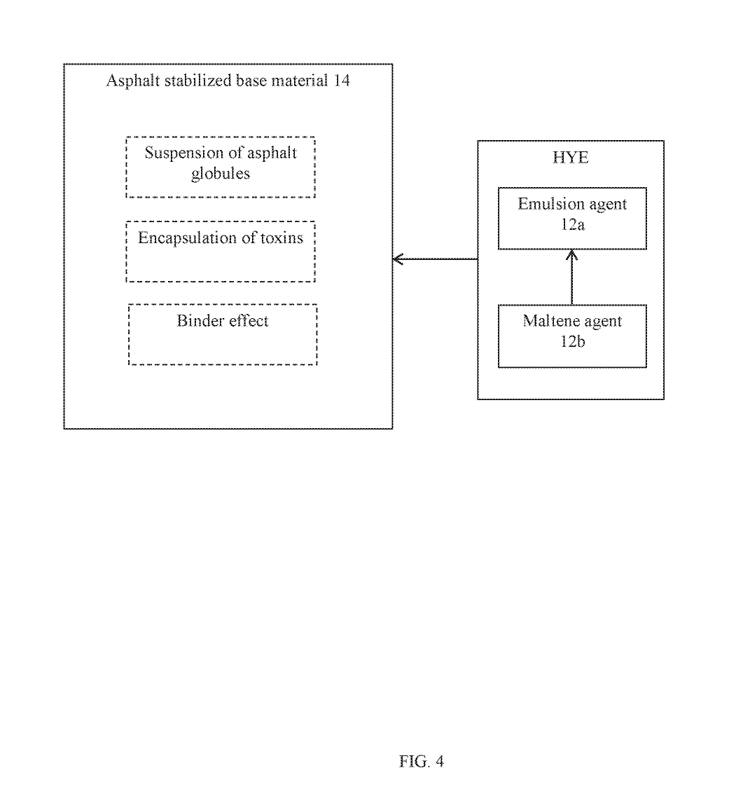

Referring to FIG. 4, embodiments of a maltene agent 12b can include aliphatic and aromatic compounds with up to 150 carbon atoms, the compounds being soluble in n-alkane solvent (e.g., pentane, heptane, etc.). In at least one embodiment, the maltene agent 12b can include a pure or purified form of maltene agent 12b. Some embodiments of the method can involve adding the maltene agent 12b to the drill cuttings 10a, the aggregate 10, the asphalt stabilized material 14, and/or the emulsion agent 12a. In at least one embodiment, the addition of maltene agent 12b to the emulsion agent 12a can generate a High Yield Emulsion (“HYE”). The HYE can be configured to reduce the amount or concentration of emulsion agent 12a needed to achieve a predetermined UCS for the asphalt stabilized material 14. The amount of maltene agent 12b that can be added can include a wide range of weight percents. The amount of maltene agent 12b added depends upon to composition of the aggregate 10, the amount and composition of emulsion agent 12a used, and the material properties desired for the asphalt stabilized material 14. Thus, monitoring and testing can be performed to the aggregate 10 and/or asphalt stabilized material 14 as the maltene agent 12b is added to determine the amount and type of maltene agent 12b needed to generate the desired material properties for the asphalt stabilized material 14. Generally, for stabilized roadway material (e.g., having a UCS equal to or greater than 35 psi), the percent maltene agent 12b can be within a range from 0.0% to 20.0%.

Tables 1-3 show the effects of using maltene agent 12b on the reduction of emulsion agent 12a needed to achieve a predetermined UCS.

Table 1 shows the effect maltene agent 12b may have on the amount of emulsion agent 12a needed to achieve a desired UCS of asphalt stabilized material 14 comprising 88% base material 10b (e.g., virgin base material or in situ road components, 22% reclaimed roadway material 10b (e.g., RAP), and use of CSS-1H emulsion agent 12a. It should be noted that the asphalt stabilized material 14 of Table 1 does not include first aggregate 10a material.

TABLE 1
Unconfined compressive strength (psi) of 88% base 22% reclaimed asphalt material
at various emulsion contents. 120-150 psi is considered minimum standard

| | | | | | | | |
|---|---|---|---|---|---|---|---|
| Emulsion content by weight | 5.00% | 4.50% | 4.00% | 3.00% | 2.50% | 2.00% | 1.50% |
| of stabilized roadway | | | | | | | |
| materials | | | | | | | |
| CSS-1H, no added maltenes | 124 | 127 | 120 | | | | |
| CSS-1H + 1.5% cement, no | 152 | 156 | 140 | | | | |
| added maltenes | | | | | | | |
| CSS-1H + 3% added maltenes | | | | | 141 | 142 | 163 |
| by weight of the stock | | | | | | | |
| asphalt in the emulsion | | | | | | | |

Table 2 shows the effect maltene agent 12b may have on the amount of emulsion agent 12a needed to achieve a desired UCS of an asphalt stabilized material 14 comprising 100% base material 10b and used of CSS-1H emulsion agent 12a. It should be noted that the asphalt stabilized material 14 of Table 2 does not include first aggregate 10a material.

TABLE 2
Unconfined compressive strength (psi) of 100% base material at
various emulsion contents. 120-150 psi is considered minimum
standard

| | Emulsion content | |
|---|---|---|
| | by weight of | |
| | stabilized roadway | |
| | materials | |
| | 6.30% | 3.00% |
| CSS-1H + 3% added fly ash, no added maltenes | 163 | |
| CSS-1H + 2% added maltenes by weight of the | | 261 |
| stock asphalt in the emulsion | | |

Table 3 shows the effect maltene agent 12b may have on the amount of emulsion agent 12a needed to achieve a desired Marshall stability of asphalt stabilized material 14 comprising 100% reclaimed material 10b and use of CMS-2S emulsion agent 12a and CSS-1H emulsion agent 12a. It should be noted that the asphalt stabilized material 14 of Table 1 does not include first aggregate 10a material.

TABLE 3
Marshall stability (psi) of 100% reclaimed asphalt pavement (RAP) material
at various emulsion contents. 1250 psi is considered minimum standard

| | | | | | | |
|---|---|---|---|---|---|---|
| Emulsion content by weight of | 4.00% | 3.50% | 3.00% | 2.50% | 2.00% | 1.50% |
| stabilized roadway materials | | | | | | |
| CMS-2 [symbol] , no added maltenes (does | 1025 | 1260 | 1360 | 1550 | | |
| contain diesel fuel) | | | | | | |
| CSS-1H + 6% added maltenes by | | | | 1375 | 1550 | 1675 |
| weight of the stock asphalt in the | | | | | | |
| emulsion | | | | | | |

[symbol]

indicates data missing or illegible when filed

### Examples of Asphaltene Agents

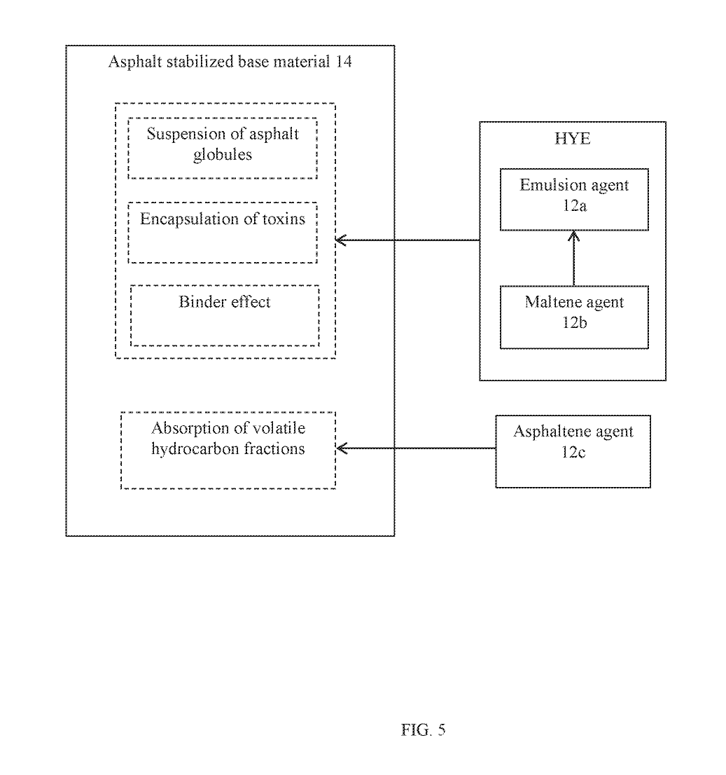

Referring to FIG. 5, embodiments of an asphaltene agent 12c can include aliphatic and aromatic compounds with up to 150 carbon atoms, the compounds being insoluble in n-alkane solvent (e.g., pentane, heptane, etc.). In at least one embodiment, the asphaltene agent 12c can include a pure or purified form of asphaltene agent 12c. Some embodiments can include adding the asphaltene agent 12c to the drill cuttings 10a, the aggregate 10, the asphalt stabilized material 14, and/or the emulsion agent 12a. The asphaltene agent 12c may be configured to absorb at least some volatile hydrocarbon fractions. This can include chemical absorption. An example of an asphaltene agent 12c can be gilsonite. The absorption of at least some volatile hydrocarbon fractions can enhance the stability of the asphalt stabilized material 14. For example, the drill cuttings 10a may contain solvents (e.g., lubricants used during the drilling process). The solvents may include volatile hydrocarbon fractions. Use of solvents during the drilling process can cause the drill cuttings 10a to have a high level of volatile hydrocarbon fractions. The existence of high levels of volatile hydrocarbon fractions in the asphalt stabilized material 14 can lower the stability of the asphalt stabilized material 14. For example, high levels of volatile hydrocarbon fractions in the asphalt stabilized material 14 can result in a soft, non-structurally sound asphalt stabilized material 14. Yet, including an asphaltene agent 12c in the asphalt stabilized material 14 can absorb at least some of the volatile hydrocarbon fractions so as to generate asphalt stabilized material 14 that has suitable stability.

The amount of asphaltene agent 12c that can be added can include a wide range of weight percents. The amount of asphaltene agent 12c added depends upon to composition of the aggregate 10, the amount and composition of the volatile hydrocarbon fractions present, and the material properties desired for the asphalt stabilized material 14. Thus, monitoring and testing can be performed to the aggregate 10 and/or asphalt stabilized material 14 as the asphaltene agent 12c is added to determine the amount and type of asphaltene agent 12c needed to generate the desired material properties for the asphalt stabilized material 14. Generally, for stabilized roadway material e.g., having a UCS equal to or greater than 35 psi), the percent asphaltene agent 12c can be within a range from 0.0% to 20.0%.

Conventional methods are generally limited to removing the volatile hydrocarbon fractions and/or incinerating the drill cuttings. Removal of the volatile hydrocarbon fractions and/or incinerating the drill cuttings can require complex, expensive, and/or time consuming procedures. Embodiments of the disclosed method, however, can allow the drill cuttings 10a to be used without removing the volatile hydrocarbon fractions and allow the asphalt stabilized material 14 produced from the drill cuttings 10a to exhibit a suitable stability.

### Exemplary Methods for Conditioning Drill Cuttings for Asphalt Cement

In some embodiments, the asphalt stabilized material 14 can include an aggregate 10 and at least one additive 12. The additive 12 can include any one or combination of an emulsion agent 12a, a maltene agent 12b, and an asphaltene agent 12c. The aggregate 10 can include one or more aggregates. A first aggregate 10a can include drill cuttings. A second aggregate 10b can include gravel, sand, crushed or pulverized cement, recycled pavement, etc. The additive 12 can be added to any one of the first aggregate 10a, the second aggregate 10b, and/or the asphalt stabilized material 14. Some embodiments can include use of more than one additive 12. A first additive can be an emulsion agent 12a. A second additive can be a maltene agent 12b. A third additive can be an asphaltene agent 12c. Any one or combination of the first, second, and third additives 12a, 12b, 12c can be mixed, combined, or placed into solution with any one or combination of the first aggregate 10a, the second aggregate 10b, and the asphalt stabilized material 14. Any one or combination of the first, second, and third additives 12a, 12b, 12c can be mixed, combined, or placed into solution with any one or combination of each other before being added to the first aggregate 10a, the second aggregate 10b, and/or the asphalt stabilized material 14. Some embodiments can include use of one or more emulsion agents 12a, one or more maltene agents 12b, and/or one or more asphaltene agents 12c. The amount/concentration of a first emulsion agent 12a can be the same as or different from the amount/concentration of a second emulsion agent 12a. The amount/concentration of a first maltene agent 12b can be the same as or different from the amount/concentration of a second maltene agent 12b. The amount/concentration of a first asphaltene agent 12c can be the same as or different from the amount/concentration of a second asphaltene agent 12c.

For example, at least one embodiment can include the addition of an emulsion agent 12a to the aggregate 10 and/or asphalt stabilized material 14. Some embodiments can include the addition of an emulsion agent 12a and a maltene agent 12c to the aggregate 10 and/or asphalt stabilized material 14. In at least one embodiment, the maltene agent 12b can be added to the emulsion agent 12a to produce a maltene-modified emulsion agent. The maltene-modified emulsion agent can then be added to the aggregate 10 and/or the asphalt stabilized material 14. Some embodiments can include the addition of an emulsion agent 12a, a maltene agent 12b, and an asphaltene agent 12c to the aggregate 10 and/or asphalt stabilized material 14. In at least one embodiment, the asphaltene agent 12c can be added to the maltene-modified emulsion agent to produce an asphaltene-maltene-modified emulsion agent. The asphaltene-maltene-modified emulsion agent can then be added to the aggregate 10 and/or the asphalt stabilized material 14.

Some embodiments can include adding an emulsion agent 12a to the aggregate 10 and/or the asphalt stabilized material 14 only if the aggregate 10 and/or the asphalt stabilized material 14 has/have a predetermined amount/concentration of toxins and/or volatile hydrocarbon fractions. Some embodiments can include adding an emulsion agent 12a to the aggregate 10 and/or the asphalt cement 15, regardless of the amount/concentration of toxins and/or the volatile hydrocarbon fractions within the aggregate 10 and/or asphalt stabilized material 14.

Some embodiments can include adding a maltene agent 12b to the emulsion agent 12a, the aggregate 10, and/or the asphalt stabilized material 14 only to reduce the amount/concentration of emulsion agent 12a required to achieve a predetermined level of stability of the asphalt stabilized material 14. Some embodiments can include adding a maltene agent 12b to the emulsion agent 12a, the aggregate 10, and/or the asphalt stabilized material 14, regardless of the reducing effect it has on the amount/concentration of emulsion agent 12a required to achieve a predetermined level of stability of the asphalt stabilized material 14.

Some embodiments can include adding an asphaltene agent 12c to the emulsion agent 12a, the aggregate 10, and/or the asphalt stabilized material 14 only when there is a high level of volatile hydrocarbon fractions in the aggregate 10 and/or the asphalt stabilized material 14. Some embodiments can include adding an asphaltene agent 12c to the emulsion agent 12a, the aggregate 10, and/or the asphalt stabilized material 14 only when volatile hydrocarbon fractions are present in the aggregate 10 and/or the asphalt stabilized material 14 and the UCS of the asphalt stabilized material 14 falls below a predetermined value. Thus, the asphaltene agent 12c can be added based on the UCS of the asphalt stabilized material 14. For example, an asphaltene agent 12c can be added when the asphalt stabilized material 14, without the asphaltene agent 12c, exhibits UCS of a predetermined value. For instance, if asphalt stabilized material 14, without an asphaltene agent 12c, has a UCS at and/or below a predetermined value then the asphaltene agent 12c may be added when producing that asphalt stabilized material 14 to increase the UCS.

The percent additives used are weight percents. For example, the percents disclosed herein for the various additives 12 are weight percents of stock asphalt. The stock asphalt can be defined as the second aggregate 12b material and any other binder material—e.g., asphalt cement. This can be used to make the “emulsion mixture”. The emulsion mixture can then be added as a weight percent based on the total aggregate weight 10a and 10b (e.g., the drill cuttings and virgin crushed stone) to be added.

As a non-limiting example, an embodiment of the method can involve forming road base material. The road base material can include combining or mixing first aggregate 10a and second aggregate 10b. This can include combining or mixing them in a pugmill. The method can further involve adding an emulsion agent 12a and/or a maltene agent 12b when forming an asphalt stabilized material 14. The asphalt stabilized material 14 can be tested to determine the UCS. If the UCS of the asphalt stabilized material 14 is at or above a predetermined value (e.g., 35 psi), then no asphaltene agent 12c is added. If the UCS of the asphalt stabilized material 14 is below a predetermined value (e.g., 35 psi), then an asphaltene agent 12c can be added to increase the UCS. The asphalt stabilized material 14 can be tested to determine the UCS at predetermined times, on a periodic schedule, etc. The addition or omission of the asphaltene agent 12c can be done based on the UCS test results. Thus, testing the UCS can be a proxy for determining that the level of volatile hydrocarbon fractions within the asphalt stabilized material 14 is high.

It should be noted that a UCS of at least 35 psi can be considered a minimum requirement for a road base material. The UCS of 35 psi can be set by governmental regulatory agencies, and thus this predetermined value can change. For example, a UCS of 40 psi or a UCS of 30 psi may be used as a minimum value for a road base material.

Some embodiments can include adding other ingredients 16 to the aggregate 10, the additive 12, and/or the asphalt stabilized material 14. (See FIG. 2). The ingredient 16 can include coloring agents, binding agents, waterproofing agents, etc.

It should be understood that adding an additive 12 and/or ingredient 16 to the aggregate 10 can include adding the additive 12 and/or ingredient 16 to the first aggregate 10a, the second aggregate 10b, or both.

Any one or combination of the additives 12 can be added to facilitate suspension of asphalt cement globules, to encapsulate toxins, to lower the amount/concentration of emulsion agent 12c required for a desired effect, and/or to absorb volatile hydrocarbon fractions. Encapsulating toxins can allow for toxins to exist, or a larger amount of toxins to exist, within the asphalt stabilized material 14 without the toxins leaching from the asphalt stabilized material 14, or at least limiting the amount and/or rate at which the toxins leach. Lowering the amount of emulsion agent 12c required to facilitate encapsulation can reduce the costs associated with producing asphalt stabilized material 14. Absorbing volatile hydrocarbon fractions can allow for volatile hydrocarbon fractions, or more volatile hydrocarbon fractions, to exist within the asphalt stabilized material 14 without degrading the material properties of the asphalt stabilized material 14, or at least limiting the degrading effect the volatile hydrocarbon fractions may have on the asphalt stabilized material 14.

Embodiments of the method can generate an asphalt stabilized base material 14 including certain toxins and limiting the amount of toxin leeching from the asphalt stabilized base material 14. Embodiments can also generate an asphalt stabilized base material 14 exhibiting a UCS of at least 35 psi. For example, an embodiment of the asphalt stabilized base material 14 can be generated exhibiting to the following parameters:

### UCS≥35 psi

Arsenic<5.00 mg/l
Barium<100.00 mg/l
Cadmium<1.00 mg/l
Chromium<5.00 mg/l
Lead<5.00 mg/l
Mercury<0.20 mg/l
Selenium<1.00 mg/l
Silver<5.00 mg/l
Zinc<5.00 mg/l
Benzene<0.50 mg/l
Chlorides<700.00 mg/l
Total petroleum hydrocarbons<100.00 mg/l
pH level 6-12.49 (s.u.)

Embodiments of the method can be used to process drill cuttings 10a, aggregate 10, and/or asphalt stabilized material 14 to be used as a product. The product can be pavement, a sidewalk, a road base material, etc. In at least one embodiment, the method can be used to generate asphalt stabilized material 14 for construction and/or maintenance of a roadway that may be used to haul extracted oil and gas. For example, asphalt stabilized material 14 can be used to construct and/or maintain haul roads, pad sites, etc. This can have the benefit of not only reducing or eliminating the costs associated with disposing the drill cuttings 10a, but also reducing the cost of maintaining the roadways used to haul extracted oil and gas, many of which can be destroyed in the process as they may not be designed to carry the loads associated with extraction.

Embodiments of the asphalt stabilized material 14 can include a first aggregate 10a and a second aggregate 10b. The amount of first aggregate 10a can range from 0% to 100%. The amount of second aggregate 10b can range from 0% to 100%. For example, the asphalt stabilized material 14 can comprise: 0% first aggregate 10a and 100% second aggregate 10b; 5% first aggregate 10a and 95% second aggregate 10b; 10% first aggregate 10a and 90% second aggregate 10b; 15% first aggregate 10a and 85% second aggregate 10b; 20% first aggregate 10a and 80% second aggregate 10b; 25% first aggregate 10a and 75% second aggregate 10b; 30% first aggregate 10a and 70% second aggregate 10b; 35% first aggregate 10a and 65% second aggregate 10b; 40% first aggregate 10a and 60% second aggregate 10b; 45% first aggregate 10a and 55% second aggregate 10b; 50% first aggregate 10a and 50% second aggregate 10b; 55% first aggregate 10a and 45% second aggregate 10b; 60% first aggregate 10a and 40% second aggregate 10b; 65% first aggregate 10a and 35% second aggregate 10b; 70% first aggregate 10a and 30% second aggregate 10b; 75% first aggregate 10a and 25% second aggregate 10b; 80% first aggregate 10a and 20% second aggregate 10b; 85% first aggregate 10a and 15% second aggregate 10b; 90% first aggregate 10a and 10% second aggregate 10b; 95% first aggregate 10a and 5% second aggregate 10b; 100% first aggregate 10a and 0% second aggregate 10b.

The amount of additive 12 can range from 0% to 100% weight percent of the asphalt stabilized material 14. For example, the amount of additive 12 added can be 0%, 5%, 10%, 15%, 20%, 25%, 30%, 35%, 40%, 45%, 50%, 55%, 60%, 65%, 70%, 75%, 80%, 85%, 90%, 95%, 100%, or any percent within 0% to 100%. The additive 12 can include a first additive 12a, a second additive 12b, and/or a third additive 12c. The amount of first additive 12a can range from 0% to 100%. The amount of second additive 12b can range from 0% to 100%. The amount of third additive 12c can range from 0% to 100%. For example, the additive 12 can comprise: 100% first additive 12a, 0% second additive 12b, 0% third additive 12c; 95% first additive 12a, 5% second additive 12b, 0% third additive 12c; 90% first additive 12a, 10% second additive 12b, 0% third additive 12c; 85% first additive 12a, 15% second additive 12b, 0% third additive 12c; 80% first additive 12a, 20% second additive 12b, 0% third additive 12c; 75% first additive 12a, 25% second additive 12b, 0% third additive 12c; 70% first additive 12a, 30% second additive 12b, 0% third additive 12c; 65% first additive 12a, 35% second additive 12b, 0% third additive 12c; 60% first additive 12a, 40% second additive 12b, 0% third additive 12c; 55% first additive 12a, 45% second additive 12b, 0% third additive 12c; 50% first additive 12a, 50% second additive 12b, 0% third additive 12c; 45% first additive 12a, 55% second additive 12b, 0% third additive 12c; 40% first additive 12a, 60% second additive 12b, 0% third additive 12c; 35% first additive 12a, 65% second additive 12b, 0% third additive 12c; 30% first additive 12a, 70% second additive 12b, 0% third additive 12c; 25% first additive 12a, 75% second additive 12b, 0% third additive 12c; 20% first additive 12a, 80% second additive 12b, 0% third additive 12c; 15% first additive 12a, 85% second additive 12b, 0% third additive 12c; 10% first additive 12a, 90% second additive 12b, 0% third additive 12c; 5% first additive 12a, 95% second additive 12b, 0% third additive 12c; 0% first additive 12a, 100% second additive 12b, 0% third additive 12c; 95% first additive 12a, 0% second additive 12b, 5% third additive 12c; 90% first additive 12a, 0% second additive 12b, 10% third additive 12c; 85% first additive 12a, 0% second additive 12b, 15% third additive 12c; 80% first additive 12a, 0% second additive 12b, 20% third additive 12c; 75% first additive 12a, 0% second additive 12b, 25% third additive 12c; 70% first additive 12a, 0% second additive 12b, 30% third additive 12c; 65% first additive 12a, 0% second additive 12b, 35% third additive 12c; 60% first additive 12a, 0% second additive 12b, 40% third additive 12c; 55% first additive 12a, 0% second additive 12b, 45% third additive 12c; 50% first additive 12a, 0% second additive 12b, 50% third additive 12c; 45% first additive 12a, 0% second additive 12b, 55% third additive 12c; 40% first additive 12a, 0% second additive 12b, 60% third additive 12c; 35% first additive 12a, 0% second additive 12b, 65% third additive 12c; 30% first additive 12a, 0% second additive 12b, 70% third additive 12c; 25% first additive 12a, 0% second additive 12b, 75% third additive 12c; 20% first additive 12a, 0% second additive 12b, 80% third additive 12c; 15% first additive 12a, 0% second additive 12b, 85% third additive 12c; 10% first additive 12a, 0% second additive 12b, 90% third additive 12c; 5% first additive 12a, 0% second additive 12b, 95% third additive 12c; 0% first additive 12a, 0% second additive 12b, 100% third additive 12c; 0% first additive 12a, 100% second additive 12b, 0% third additive 12c; 5% first additive 12a, 95% second additive 12b, 0% third additive 12c; 10% first additive 12a, 90% second additive 12b, 0% third additive 12c; 15% first additive 12a, 85% second additive 12b, 0% third additive 12c; 20% first additive 12a, 80% second additive 12b, 0% third additive 12c; 25% first additive 12a, 75% second additive 12b, 0% third additive 12c; 30% first additive 12a, 70% second additive 12b, 0% third additive 12c; 35% first additive 12a, 65% second additive 12b, 0% third additive 12c; 40% first additive 12a, 60% second additive 12b, 0% third additive 12c; 45% first additive 12a, 55% second additive 12b, 0% third additive 12c; 50% first additive 12a, 50% second additive 12b, 0% third additive 12c; 55% first additive 12a, 45% second additive 12b, 0% third additive 12c; 60% first additive 12a, 40% second additive 12b, 0% third additive 12c; 65% first additive 12a, 35% second additive 12b, 0% third additive 12c; 70% first additive 12a, 30% second additive 12b, 0% third additive 12c; 75% first additive 12a, 25% second additive 12b, 0% third additive 12c; 80% first additive 12a, 20% second additive 12b, 0% third additive 12c; 85% first additive 12a, 15% second additive 12b, 0% third additive 12c; 90% first additive 12a, 10% second additive 12b, 0% third additive 12c; 95% first additive 12a, 5% second additive 12b, 0% third additive 12c; 100% first additive 12a, 0% second additive 12b, 0% third additive 12c; 0% first additive 12a, 95% second additive 12b, 5% third additive 12c; 0% first additive 12a, 90% second additive 12b, 10% third additive 12c; 0% first additive 12a, 85% second additive 12b, 15% third additive 12c; 0% first additive 12a, 80% second additive 12b, 20% third additive 12c; 0% first additive 12a, 75% second additive 12b, 25% third additive 12c; 0% first additive 12a, 70% second additive 12b, 30% third additive 12c; 0% first additive 12a, 65% second additive 12b, 35% third additive 12c; 0% first additive 12a, 60% second additive 12b, 40% third additive 12c; 0% first additive 12a, 55% second additive 12b, 45% third additive 12c; 0% first additive 12a, 50% second additive 12b, 50% third additive 12c; 0% first additive 12a, 45% second additive 12b, 55% third additive 12c; 0% first additive 12a, 40% second additive 12b, 60% third additive 12c; 0% first additive 12a, 35% second additive 12b, 65% third additive 12c; 0% first additive 12a, 30% second additive 12b, 70% third additive 12c; 0% first additive 12a, 25% second additive 12b, 75% third additive 12c; 0% first additive 12a, 20% second additive 12b, 80% third additive 12c; 0% first additive 12a, 15% second additive 12b, 85% third additive 12c; 0% first additive 12a, 10% second additive 12b, 90% third additive 12c; 0% first additive 12a, 5% second additive 12b, 95% third additive 12c; 0% first additive 12a, 0% second additive 12b, 100% third additive 12c; 0% first additive 12a, 0% second additive 12b, 100% third additive 12c; 5% first additive 12a, 0% second additive 12b, 95% third additive 12c; 10% first additive 12a, 0% second additive 12b, 90% third additive 12c; 15% first additive 12a, 0% second additive 12b, 85% third additive 12c; 20% first additive 12a, 0% second additive 12b, 80% third additive 12c; 25% first additive 12a, 0% second additive 12b, 75% third additive 12c; 30% first additive 12a, 0% second additive 12b, 70% third additive 12c; 35% first additive 12a, 0% second additive 12b, 65% third additive 12c; 40% first additive 12a, 0% second additive 12b, 60% third additive 12c; 45% first additive 12a, 0% second additive 12b, 55% third additive 12c; 50% first additive 12a, 0% second additive 12b, 50% third additive 12c; 55% first additive 12a, 0% second additive 12b, 45% third additive 12c; 60% first additive 12a, 0% second additive 12b, 40% third additive 12c; 65% first additive 12a, 0% second additive 12b, 35% third additive 12c; 70% first additive 12a, 0% second additive 12b, 30% third additive 12c; 75% first additive 12a, 0% second additive 12b, 25% third additive 12c; 80% first additive 12a, 0% second additive 12b, 20% third additive 12c; 85% first additive 12a, 0% second additive 12b, 15% third additive 12c; 90% first additive 12a, 0% second additive 12b, 10% third additive 12c; 95% first additive 12a, 0% second additive 12b, 5% third additive 12c; 100% first additive 12a, 0% second additive 12b, 0% third additive 12c; 0% first additive 12a, 5% second additive 12b, 95% third additive 12c; 0% first additive 12a, 10% second additive 12b, 90% third additive 12c; 0% first additive 12a, 15% second additive 12b, 85% third additive 12c; 0% first additive 12a, 20% second additive 12b, 80% third additive 12c; 0% first additive 12a, 25% second additive 12b, 75% third additive 12c; 0% first additive 12a, 30% second additive 12b, 70% third additive 12c; 0% first additive 12a, 35% second additive 12b, 65% third additive 12c; 0% first additive 12a, 40% second additive 12b, 60% third additive 12c; 0% first additive 12a, 45% second additive 12b, 55% third additive 12c; 0% first additive 12a, 50% second additive 12b, 50% third additive 12c; 0% first additive 12a, 55% second additive 12b, 45% third additive 12c; 0% first additive 12a, 60% second additive 12b, 40% third additive 12c; 0% first additive 12a, 65% second additive 12b, 35% third additive 12c; 0% first additive 12a, 70% second additive 12b, 30% third additive 12c; 0% first additive 12a, 75% second additive 12b, 25% third additive 12c; 0% first additive 12a, 80% second additive 12b, 20% third additive 12c; 0% first additive 12a, 85% second additive 12b, 15% third additive 12c; 0% first additive 12a, 90% second additive 12b, 10% third additive 12c; 0% first additive 12a, 95% second additive 12b, 5% third additive 12c; 0% first additive 12a, 100% second additive 12b, 0% third additive 12c.

The amount of ingredient 16 can range from 0% to 100% weight percent of the asphalt stabilized material 14. For example, the amount of ingredient 16 added can be 0%, 5%, 10%, 15%, 20%, 25%, 30%, 35%, 40%, 45%, 50%, 55%, 60%, 65%, 70%, 75%, 80%, 85%, 90%, 95%, 100%, or any percent within 0% to 100%.

Table 4 shows various embodiment of an asphalt stabilized material 14 generated from the inventive method.

TABLE 4

| | Emulsion | | | |
|---|---|---|---|---|
| | PRO RAP | | DRILL CUTTING EMULSION | |
| | Lab Number | | | |
| | 172705 | 172707 | 172706 | 172708 |
| | Blend | | | |
| | 70% Add | 60% Add | 70% Add | 60% Add |
| | Rock/30% Oil | Rock/40% Oil | Rock/30% Oil | Rock/40% Oil |
| | Cuttings | Cuttings | Cuttings | Cuttings |
| Percent Emulsion | 2.25 | 2.25 | 2.25 | 2.25 |
| % H2O | 7.0 | 7.0 | 7.0 | 7.0 |
| Wet Density, lbs/ft\hat{ }3 | 137.0 | 139.2 | 139.4 | 138.5 |
| 48 Hr Cure @ 60° C. | 70 | 46 | 45 | 49 |
| Unconfined Compressive | | | | |
| Strength (psi) @ 25° C. | | | | |
| [Tex.117-E] | | | | |

The result of Table 4 demonstrate that the effect the addition of an asphaltene agent 12c can have on the UCS of an asphalt stabilized material 14 comprising drill cuttings with high levels of volatile hydrocarbon fractions. For example, Lab Number 172705 shows use of 30% of second aggregate (e.g., drill cuttings) having high levels of volatile hydrocarbon fractions. Lab Number 17207 shows use of 40% of second aggregate (e.g., drill cuttings) having high levels of volatile hydrocarbon fractions. It can be seen that Lab Number 17207 exhibits a UCS of 46 psi, which is above the minimum 35 psi. Similarly, Lab Number 172706 shows use of 30% of second aggregate (e.g., drill cuttings) having high levels of volatile hydrocarbon fractions. Lab Number 17208 shows use of 40% of second aggregate (e.g., drill cuttings) having high levels of volatile hydrocarbon fractions. It can be seen that Lab Number 17208 exhibits a UCS of 49 psi, which is above the minimum 35 psi.

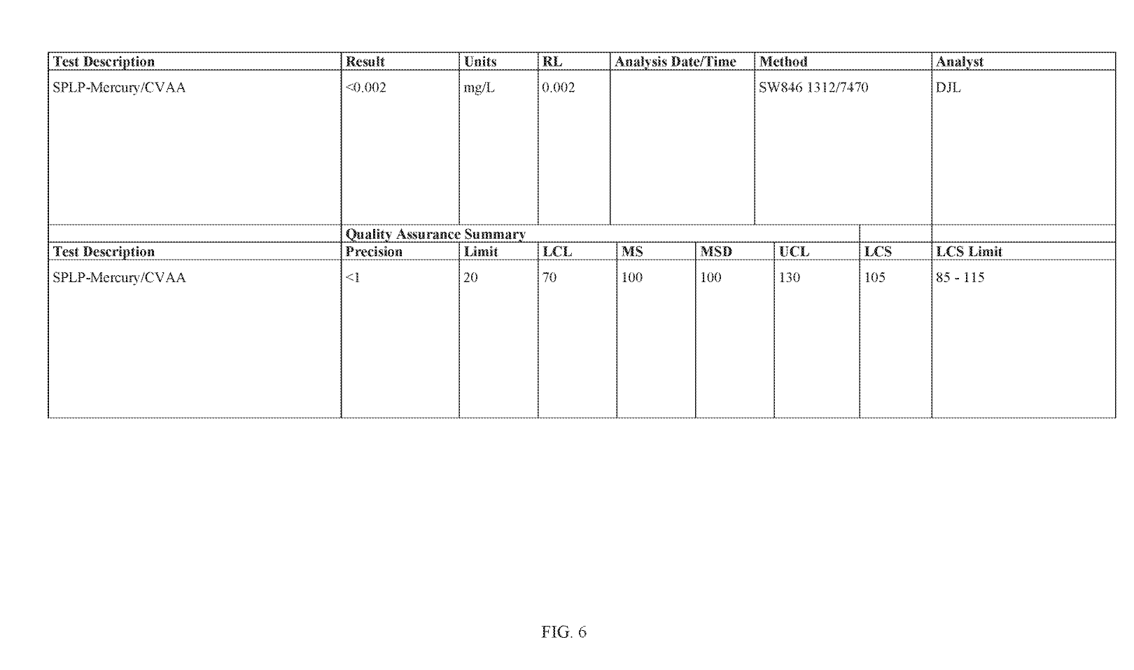

Tables 5 and 6 and FIGS. 6-9 show environmental data results demonstrating that embodiments of the inventive method can generate a conditioned material 14 that meets the desired leaching requirements. Methods for testing included EPA 300 and EPA 9253, which are EPA test standards. Table 5 shows test results for four test samples. Table 6 shows that the leachable amount was acceptable in accordance with Texas Railroad Commission requirements.

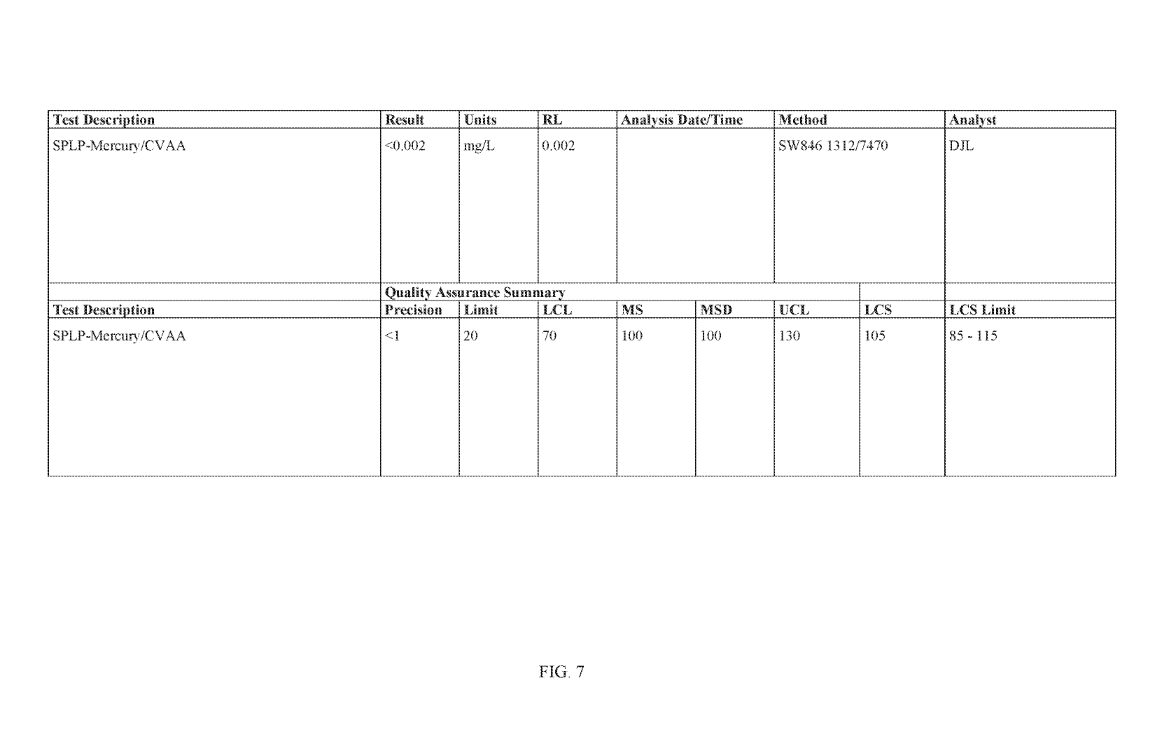

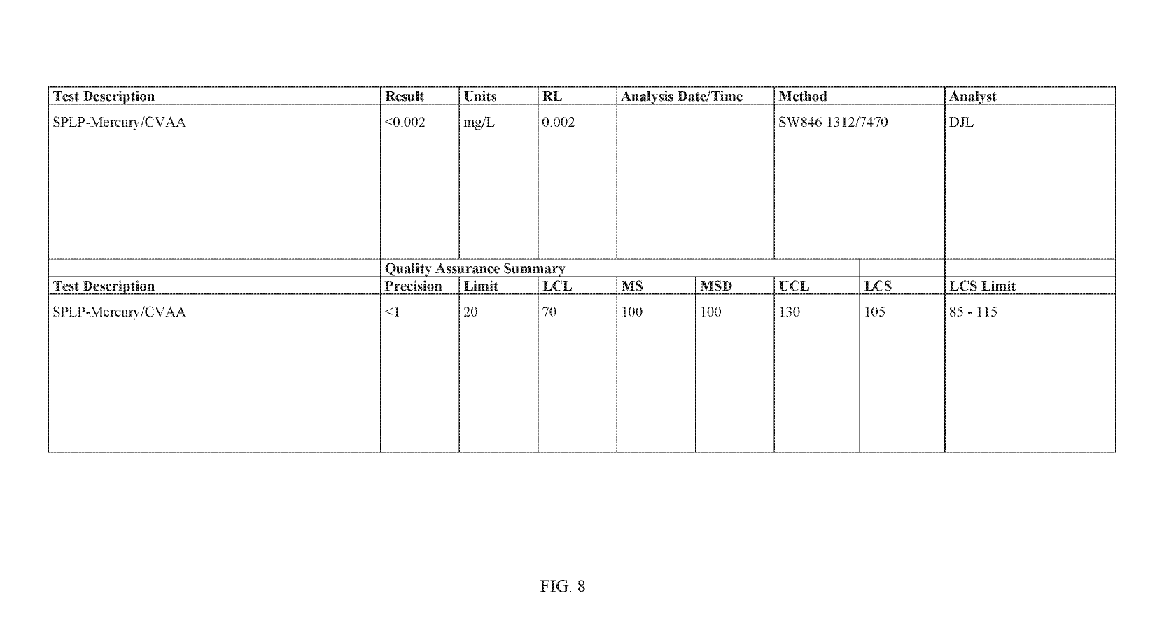

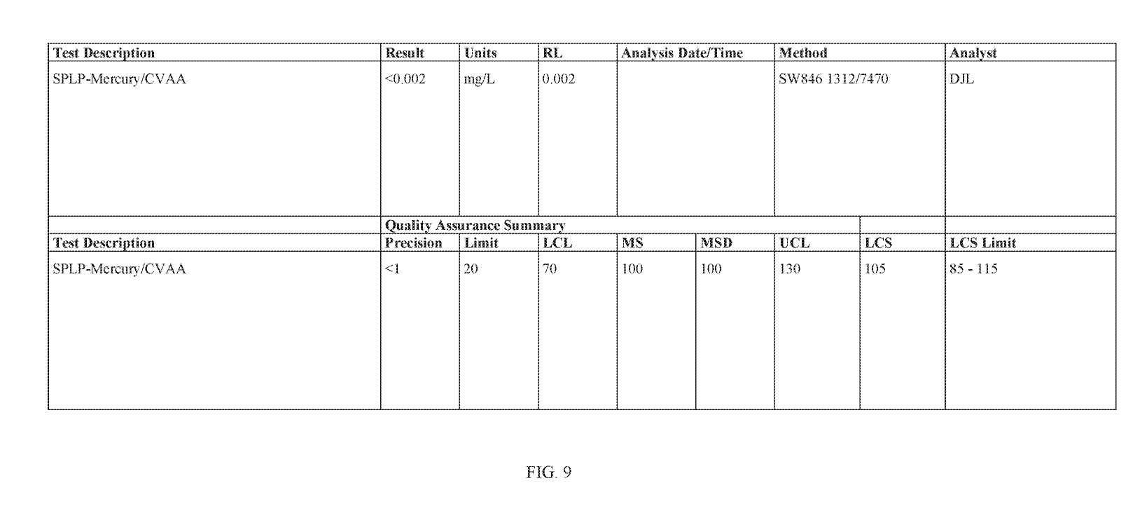

FIG. 6 shows additional results related to sample ID: S172131149. FIG. 7 shows additional results related to Sample ID: S172131151. FIG. 8 shows additional results related to Sample ID: S172131152. FIG. 9 shows additional results related to Sample ID: S17213115A.

TABLE 5

| | | | | | | | |
|---|---|---|---|---|---|---|---|
| Analyte | Result | Units | Method | OQ | DL | F | Qual |

(ix) Sample ID: S172131149

| | | | | | |
|---|---|---|---|---|---|
| Chloride, IC | 64 | g/L | PA 300 | | |
| -SPLP-Extraction-M | | | W-1312 | | |
| -SPLP-Extraction-V | | | W-1312 | | |
| 7-Day Leachate | | | a 29B | | |
| H (Standard Units) | .96 | U | M 4500-H + B | | |
| P-Arsenic, ICP | 0.01 | g/L | W-6010B | .01 | .01 |
| P-Barium, ICP | .073 | g/L | W-6010B | .01 | .01 |
| P-Cadmium, ICP | 0.005 | g/L | W-6010B | .005 | .005 |
| P-Chromium, ICP | 0.005 | g/L | W-6010B | .005 | .005 |
| P-Lead, ICP | 0.01 | g/L | W-6010B | .01 | .01 |
| P-Mercury, CVAA | 0.002 | g/L | PA 245.1/7470 | .002 | .002 |
| P-Selenium, ICP | 0.02 | g/L | W-6010B | .02 | .02 |
| P-Silver, ICP | <0.01 | mg/L | SW-6010B | .01 | .01 |
| PH-L. nC6-nC12 | <2 | mg/L | TX 1005 | | .55 |
| PH-L. >nC12-nC28 | 2 | mg/L | TX 1005 | | .85 |
| PH-L. >nC28-nC35 | <2 | mg/L | TX 1005 | | |
| PH-L. Total nC6-nC35 | 2 | mg/L | TX 1005 | | .37 |
| PH-Surr. 1-Chlorooctad | 101 | % | TX 1005 | 0 | 30 |
| VOC-L. Benzene | <0.004 | mg/L | SW 8260B | .001 | .0003 |
| VOC-Surr: .DBFM | 115 | | SW 8260B | 80 | 20 |
| VOC-Surr: .DCE-d4 | 116 | | SW 8260B | 80 | 20 |
| VOC-Surr: .T-d8 | 98.5 | % | SW 8260B | 80 | 20 |
| VOC-Surr: 4-BFB | 90 | % | SW8260B | 75 | 20 |

(cii) Sample ID: S172131151

| | | | | | |
|---|---|---|---|---|---|
| Chloride, IC | 53 | g/L | PA 300 | | |
| -SPLP-Extraction-M | | | W-1312 | | |
| -SPLP-Extraction-V | | | W-1312 | | |
| 7-Day Leachate | | | a 29B | | |
| H (Standard Units) | .36 | U | M 4500-H + B | | |
| P-Arsenic, ICP | 0.01 | g/L | W-6010B | .01 | .01 |
| P-Barium, ICP | .083 | g/L | W-6010B | .01 | .01 |
| P-Cadmium, ICP | 0.005 | g/L | W-6010B | .005 | .005 |
| P-Chromium, ICP | 0.005 | g/L | W-6010B | .005 | .005 |
| P-Lead, ICP | 0.01 | g/L | W-6010B | .01 | .01 |
| P-Mercury, CVAA | 0.002 | g/L | PA 245.1/7470 | .002 | .002 |
| P-Selenium, ICP | 0.02 | g/L | W-6010B | .02 | .02 |
| P-Silver, ICP | <0.01 | mg/L | SW-6010B | .01 | .01 |
| PH-L. nC6-nC12 | <2 | mg/L | TX 1005 | | .55 |
| PH-L. >nC12-nC28 | 2 | mg/L | TX 1005 | | .85 |
| PH-L. >nC28-nC35 | <2 | mg/L | TX 1005 | | |
| PH-L. Total nC6-nC35 | 2 | mg/L | TX 1005 | | .37 |
| PH-Surr. 1-Chlorooctad | 96.8 | % | TX 1005 | 0 | 30 |
| VOC-L. Benzene | <0.004 | mg/L | SW 8260B | .001 | .0003 |
| VOC-Surr: .DBFM | 113 | | SW 8260B | 80 | 20 |
| VOC-Surr: .DCE-d4 | 116 | | SW 8260B | 80 | 20 |
| VOC-Surr: .T-d8 | 101 | % | SW 8260B | 80 | 20 |
| VOC-Surr: 4-BFB | 89.6 | % | SW8260B | 75 | 20 |

(cxcv) Sample ID: S172131152

| | | | | | |
|---|---|---|---|---|---|
| Chloride, IC | 27 | g/L | PA 300 | | |
| -SPLP-Extraction-M | | | W-1312 | | |
| -SPLP-Extraction-V | | | W-1312 | | |
| 7-Day Leachate | | | a 29B | | |
| H (Standard Units) | .33 | U | M 4500-H + B | | |
| P-Arsenic, ICP | 0.01 | g/L | W-6010B | .01 | .01 |
| P-Barium, ICP | .068 | g/L | W-6010B | .01 | .01 |
| P-Cadmium, ICP | 0.005 | g/L | W-6010B | .005 | .005 |
| P-Chromium, ICP | 0.005 | g/L | W-6010B | .005 | .005 |
| P-Lead, ICP | 0.01 | g/L | W-6010B | .01 | .01 |
| P-Mercury, CVAA | 0.002 | g/L | PA 245.1/7470 | .002 | .002 |
| P-Selenium, ICP | 0.02 | g/L | W-6010B | 0.02 | .02 |
| P-Silver, ICP | <0.01 | mg/L | SW-6010B | .01 | .01 |
| PH-L. nC6-nC12 | <2 | mg/L | TX 1005 | | .55 |
| PH-L. >nC12-nC28 | 2 | mg/L | TX 1005 | | .85 |
| PH-L. >nC28-nC35 | <2 | mg/L | TX 1005 | | |
| TPH-L. Total nC6-nC35 | 2 | mg/L | TX 1005 | | .37 |
| PH-Surr. 1-Chlorooctad | 96.8 | % | TX 1005 | 0 | 30 |
| VOC-L. Benzene | <0.004 | mg/L | SW 8260B | .001 | .0003 |
| VOC-Surr: .DBFM | 111 | | SW 8260B | 80 | 20 |
| VOC-Surr: .DCE-d4 | 117 | | SW 8260B | 80 | 20 |
| VOC-Surr: .T-d8 | 98.2 | % | SW 8260B | 80 | 20 |
| VOC-Surr: 4-BFB | 90.5 | % | SW8260B | 75 | 20 |

(cclxxxvi) Sample ID: S17213115A

| | | | | | |
|---|---|---|---|---|---|
| - Chloride, IC | 608 | mg/L | EPA 300 | 1 | |
| 1-SPLP-Extraction-M | c | # | SW-1312 | | |
| 1-SPLP-Extraction-V | c | # | SW-1312 | | |
| -7-Day Leachate | c | # | La 29B | | |
| pH (Standard Units) | 7.44 | SU | SM 4500-H + B | 2 | |
| SP-Arsenic, ICP | <0.01 | mg/L | SW-6010B | 0.01 | .01 |
| SP-Barium, ICP | 0.095 | mg/L | SW-6010B | 0.01 | .01 |
| SP-Cadmium, ICP | <0.005 | mg/L | SW-6010B | 0.005 | .005 |
| SP-Chromium, ICP | <0.005 | mg/L | SW-6010B | 0.005 | .005 |
| SP-Lead, ICP | <0.01 | mg/L | SW-6010B | 0.01 | .01 |
| SP-Mercury, CVAA | <0.002 | mg/L | EPA 245.1/7470 | 0.002 | .002 |
| SP-Selenium, ICP | <0.02 | mg/L | SW-6010B | 0.02 | .02 |
| SP-Silver, ICP | <0.01 | mg/L | SW-6010B | 0.01 | .01 |
| TPH-L. nC6-nC12 | <2 | mg/L | TX 1005 | 2 | .55 |
| TPH-L. >nC12-nC28 | 3 | mg/L | TX 1005 | 2 | .85 |
| TPH-L. >nC28-nC35 | <2 | mg/L | TX 1005 | 2 | |
| TPH-L. Total nC6-nC35 | 3 | mg/L | TX 1005 | 2 | .37 |
| TPH-Surr. 1-Chlorooctad | 96.8 | % | TX 1005 | 70 | 30 |
| VOC-L. Benzene | <0.004 | mg/L | SW 8260B | 0.001 | .0003 |
| VOC-Surr: .DBFM | 112 | | SW 8260B | 80 | 20 |
| VOC-Surr: .DCE-d4 | 117 | | SW 8260B | 80 | 20 |
| VOC-Surr: .T-d8 | 101 | | SW 8260B | 80 | 20 |
| VOC-Surr: 4-BFB | 89.6 | % | SW 8260B | 75 | 20 |

TABLE 6

| | | | | | | | | | |
|---|---|---|---|---|---|---|---|---|---|
| | | | Ref | Amt | | | | | |
| [symbol] arameter | ID | Result | Value | Added | LOQ | Qualifier | Control | Flag | Comments |

(cccxi) Method Blank

| | | | | | | | |
|---|---|---|---|---|---|---|---|
| Chloride, IC | 172262132 | 1 | mg/L | | | | [symbol] lank |
| [symbol] /9/2017 | | | | | | | Acceptable. |
| P-Arsenic, | 172231015 | 0.01 | mg/L | | .01 | .01 | [symbol] lank |
| ICP | | | | | | | Acceptable. |
| [symbol] /9/2017 | | | | | | | |
| P-Barium, | 172231015 | 0.01 | mg/L | | .01 | .01 | [symbol] lank |
| ICP | | | | | | | Acceptable. |
| [symbol] /9/2017 | | | | | | | |
| P-Cadmium, | 172231015 | 0.005 | mg/L | | .005 | .005 | [symbol] lank |
| ICP | | | | | | | Acceptable. |
| [symbol] /9/2017 | | | | | | | |
| P-Chromium, | 172231015 | 0.005 | mg/L | | .005 | .005 | [symbol] lank |
| ICP | | | | | | | Acceptable. |
| [symbol] /9/2017 | | | | | | | |
| P-Lead, ICP | 172231015 | 0.01 | mg/L | | .01 | .01 | [symbol] lank |
| [symbol] /9/2017 | | | | | | | Acceptable. |
| P-Selenium, | 172231015 | 0.02 | mg/L | | .02 | .02 | [symbol] lank |
| ICP | | | | | | | Acceptable. |
| [symbol] /9/2017 | | | | | | | |
| P-Silver, ICP | 172231015 | 0.1 | mg/L | | .01 | .01 | [symbol] lank |
| [symbol] /9/2017 | | | | | | | Acceptable. |
| PH-L. Total | 172262154 | 2 | mg/L | | | | [symbol] lank |
| nC6-nC3 | | | | | | | Acceptable |
| [symbol] /9/2017 | | | | | | | |
| OC-L. | 172231322 | 0.001 | mg/L | .001 | .001 | .001 | [symbol] lank |
| Benzene | | | | | | | Acceptable. |
| [symbol] /10/2017 | | | | | | | |

(cccxcii) Duplicate

| | | | | | | | | |
|---|---|---|---|---|---|---|---|---|
| H (Standard | 172201606 | .99 | SU | .96 | | .4% | 0 | [symbol] uplicate |
| Units) | | | | | | | | RPD |
| [symbol] /8/2017 | | | | | | | | Acceptable. |
| OC-L. | 17223132B | .01971 | mg/L | .01945 | .001 | .3% | 0 | [symbol] uplicate |
| Benzene | | | | | | | | RPD |
| [symbol] /10/2017 | | | | | | | | Acceptable. |

(cdxi) Laboratory Control Standard

| | | | | | | | | |
|---|---|---|---|---|---|---|---|---|
| Chloride, IC | 172262134 | 5.6 | mg/L | 5 | | 02.4% | 0-120 | [symbol] tandard |
| 8/9/2017 | | | | | | .4% | 0 | Recovery |
| | | | | | | | | Acceptable. |
| | | | | | | | | [symbol] tandard |
| | | | | | | | | RPD |
| | | | | | | | | Acceptable. |
| H (Standard | 172201605 | .98 | SU | | | 9.7% | 0-120 | [symbol] tandard |
| Units) | | | | | | .3% | 0 | Recovery |
| 8/8/2017 | | | | | | | | Acceptable. |
| | | | | | | | | [symbol] tandard |
| | | | | | | | | RPD |
| | | | | | | | | Acceptable. |
| P-Arsenic, | 172231017 | .53 | mg/L | .5 | .01 | 06.0% | 0-120 | [symbol] tandard |
| ICP | | | | | | .8% | 0 | Recovery |
| [symbol] /9/2017 | | | | | | | | Acceptable. |
| | | | | | | | | [symbol] tandard |
| | | | | | | | | RPD |
| | | | | | | | | Acceptable. |
| P-Barium, | 172231017 | .52 | mg/L | .5 | .01 | 04.0% | 0-120 | [symbol] tandard |
| ICP | | | | | | .9% | 0 | Recovery |
| [symbol] /9/2017 | | | | | | | | Acceptable. |
| | | | | | | | | [symbol] tandard |
| | | | | | | | | RPD |
| | | | | | | | | Acceptable. |
| P-Cadmium, | 172231017 | .52 | mg/L | .5 | .005 | 04.0% | 0-120 | [symbol] tandard |
| ICP | | | | | | .9% | 0 | Recovery |
| [symbol] /9/2017 | | | | | | | | Acceptable. |
| | | | | | | | | [symbol] tandard |
| | | | | | | | | RPD |
| | | | | | | | | Acceptable. |
| P-Chromium, | 172231017 | .51 | mg/L | .5 | .005 | 02.0% | 0-120 | [symbol] tandard |
| ICP | | | | | | .0% | 0 | Recovery |
| [symbol] /9/2017 | | | | | | | | Acceptable. |
| | | | | | | | | [symbol] tandard |
| | | | | | | | | RPD |
| | | | | | | | | Acceptable. |
| P-Lead, ICP | 172231017 | .52 | mg/L | .5 | .01 | 04.0% | 0-120 | [symbol] tandard |
| [symbol] /9/2017 | | | | | | .9% | 0 | Recovery |
| | | | | | | | | Acceptable. |
| | | | | | | | | [symbol] tandard |
| | | | | | | | | RPD |
| | | | | | | | | Acceptable. |
| P-Selenium, | 172231017 | .52 | mg/L | .5 | .02 | 04.0% | 0-120 | [symbol] tandard |
| ICP | | | | | | .9% | 0 | Recovery |
| [symbol] /9/2017 | | | | | | | | Acceptable. |
| | | | | | | | | [symbol] tandard |
| | | | | | | | | RPD |
| | | | | | | | | Acceptable. |
| P-Silver, ICP | 172231017 | .105 | mg/L | .1 | .01 | 05.0% | 0-120 | [symbol] tandard |
| [symbol] /9/2017 | | | | | | .9% | 0 | Recovery |
| | | | | | | | | Acceptable. |
| | | | | | | | | [symbol] tandard |
| | | | | | | | | RPD |
| | | | | | | | | Acceptable. |
| PH-L. Total | 172262155 | 8 | mg/L | 00 | | 8.0% | 5-125 | [symbol] tandard |
| nC6-nC3 | | | | | | 2.8% | 5 | Recovery |
| [symbol] /9/2017 | | | | | | | | Acceptable. |
| | | | | | | | | [symbol] tandard |
| | | | | | | | | RPD |
| | | | | | | | | Acceptable. |
| OC-L. | 172231324 | .01993 | mg/L | .02 | .001 | 9.7% | 0-120 | [symbol] tandard |
| Benzene | | | | | | .4% | 0 | Recovery |
| [symbol] /10/2017 | | | | | | | | Acceptable. |
| | | | | | | | | [symbol] tandard |
| | | | | | | | | RPD |
| | | | | | | | | Acceptable. |

(dxlii) Matrix Spike

| | | | | | | | | | |
|---|---|---|---|---|---|---|---|---|---|
| Chloride, IC | 17226213A | 69 | mg/L | 57 | 50 | | 04.8% | 0-120 | [symbol] pike |
| [symbol] /9/2017 | | | | | | | .4% | 0 | Recovery |
| | | | | | | | | | Acceptable. |
| | | | | | | | | | [symbol] pike RPD |
| | | | | | | | | | Acceptable. |
| P-Arsenic, | 172231018 | .54 | mg/L | .5 | .5 | .01 | 08.0% | 0-120 | [symbol] pike |
| ICP | | | | | | | .7% | 0 | Recovery |
| [symbol] /9/2017 | | | | | | | | | Acceptable. |
| | | | | | | | | | [symbol] pike RPD |
| | | | | | | | | | Acceptable. |
| P-Barium, | 172231018 | .616 | mg/L | .573 | .5 | .01 | 08.6% | 0-130 | [symbol] pike |
| ICP | | | | | | | .2% | 0 | Recovery |
| [symbol] /9/2017 | | | | | | | | | Acceptable. |
| | | | | | | | | | [symbol] pike RPD |
| | | | | | | | | | Acceptable. |
| P-Cadmium, | 172231018 | .52 | mg/L | .5 | .5 | .005 | 04.0% | 0-120 | [symbol] pike |
| ICP | | | | | | | .9% | 5 | Recovery |
| [symbol] /9/2017 | | | | | | | | | Acceptable. |
| | | | | | | | | | [symbol] pike RPD |
| | | | | | | | | | Acceptable. |
| P-Chromium, | 172231018 | .51 | mg/L | .5 | .5 | .005 | 02.0% | 0-120 | [symbol] pike |
| ICP | | | | | | | .0% | 0 | Recovery |
| [symbol] /9/2017 | | | | | | | | | Acceptable. |
| | | | | | | | | | [symbol] pike RPD |
| | | | | | | | | | Acceptable. |
| P-Lead, ICP | 172231018 | .51 | mg/L | .5 | .5 | .01 | 02.0% | 0-120 | [symbol] pike |
| [symbol] /9/2017 | | | | | | | .0% | 0 | Recovery |
| | | | | | | | | | Acceptable. |
| | | | | | | | | | [symbol] pike RPD |
| | | | | | | | | | Acceptable. |
| P-Selenium, | 172231018 | .54 | mg/L | .5 | .5 | .02 | 08.0% | 0-120 | [symbol] pike |
| ICP | | | | | | | .7% | 0 | Recovery |
| [symbol] /9/2017 | | | | | | | | | Acceptable. |
| | | | | | | | | | [symbol] pike RPD |
| | | | | | | | | | Acceptable. |
| P-Silver, ICP | 172231018 | .106 | mg/L | .1 | .1 | .01 | 06.0% | 0-120 | [symbol] pike |
| [symbol] /9/2017 | | | | | | | .8% | 0 | Recovery |
| | | | | | | | | | Acceptable. |
| | | | | | | | | | S [symbol] pike RPD |
| | | | | | | | | | Acceptable. |
| PH-L. Total | 17226215A | 1 | mg/L | 02 | 00 | | 9.0% | 5-125 | [symbol] pike |
| nC6-nC3 | | | | | | | 3.0% | 5 | Recovery |
| [symbol] /9/2017 | | | | | | | | | Acceptable. |
| | | | | | | | | | [symbol] pike RPD |
| | | | | | | | | | Acceptable. |
| OC-L. | 172231325 | .01945 | mg/L | .02 | .02 | .001 | 7.3% | 0-120 | [symbol] pike |
| Benzene | | | | | | | .8% | 0 | Recovery |
| [symbol] /10/2017 | | | | | | | | | Acceptable. |
| | | | | | | | | | [symbol] pike RPD |
| | | | | | | | | | Acceptable. |

(dclxxii) Matrix Spike Dup

| | | | | | | | | | |
|---|---|---|---|---|---|---|---|---|---|
| Chloride, IC | 17226213B | 67 | mg/L | 57 | 50 | | 04.0% | 0-120 | [symbol] pike |
| [symbol] /9/2017 | | | | | | | .2% | 0 | Recovery |
| | | | | | | | | | Acceptable. |
| | | | | | | | | | [symbol] pike RPD |
| | | | | | | | | | Acceptable. |
| P-Arsenic, | 17223101A | .53 | mg/L | .5 | .5 | .01 | 06.0% | 0-120 | [symbol] pike |
| ICP | | | | | | | .8% | 0 | Recovery |
| [symbol] /9/2017 | | | | | | | | | Acceptable. |
| | | | | | | | | | [symbol] pike RPD |
| | | | | | | | | | Acceptable. |
| P-Barium, | 17223101A | .599 | mg/L | .573 | .5 | .01 | 05.2% | 0-130 | [symbol] pike |
| ICP | | | | | | | .4% | 0 | Recovery |
| [symbol] /9/2017 | | | | | | | | | Acceptable. |
| | | | | | | | | | [symbol] pike RPD |
| | | | | | | | | | Acceptable. |
| P-Cadmium, | 17223101A | .52 | mg/L | .5 | .5 | .005 | 04.0% | 0-120 | [symbol] pike |
| ICP | | | | | | | .9% | 25 | Recovery |
| [symbol] /9/2017 | | | | | | | | | Acceptable. |
| | | | | | | | | | [symbol] pike RPD |
| | | | | | | | | | Acceptable. |
| P-Chromium, | 17223101A | .51 | mg/L | .5 | .5 | .005 | 02.0% | 0-120 | [symbol] pike |
| ICP | | | | | | | .0% | 0 | Recovery |
| [symbol] /9/2017 | | | | | | | | | Acceptable. |
| | | | | | | | | | [symbol] pike RPD |
| | | | | | | | | | Acceptable. |
| P-Lead, ICP | 17223101A | .51 | mg/L | .5 | .5 | .01 | 02.0% | 0-120 | [symbol] pike |
| [symbol] /9/2017 | | | | | | | .0% | 0 | Recovery |
| | | | | | | | | | Acceptable. |
| | | | | | | | | | [symbol] pike RPD |
| | | | | | | | | | Acceptable. |
| P-Selenium, | 17223101A | .54 | mg/L | .5 | .5 | .02 | 08.0% | 0-120 | [symbol] pike |
| ICP | | | | | | | .7% | 0 | Recovery |
| [symbol] /9/2017 | | | | | | | | | Acceptable. |
| | | | | | | | | | [symbol] pike RPD |
| | | | | | | | | | Acceptable. |
| P-Silver, ICP | 17223101A | .108 | mg/L | .1 | .1 | .01 | 08.0% | 0-120 | [symbol] pike |
| [symbol] /9/2017 | | | | | | | .7% | 0 | Recovery |
| | | | | | | | | | Acceptable. |
| | | | | | | | | | [symbol] pike RPD |
| | | | | | | | | | Acceptable. |
| PH-L. Total | 17226215B | 0 | mg/L | 02 | 00 | | 8.0% | 75-125 | [symbol] pike |
| nC6-nC3 | | | | | | | 4.2% | 5 | Recovery |
| [symbol] /9/2017 | | | | | | | | | Acceptable. |
| | | | | | | | | | [symbol] pike RPD |
| | | | | | | | | | Acceptable. |
| OC-L. | 17223132A | .01971 | mg/L | .02 | .02 | .001 | 8.6% | 0-120 | [symbol] pike |
| Benzene | | | | | | | .5% | 0 | Recovery |
| [symbol] /10/2017 | | | | | | | | | Acceptable. |
| | | | | | | | | | [symbol] pike RPD |
| | | | | | | | | | Acceptable. |

[symbol]

indicates data missing or illegible when filed

### EXAMPLES

### Example 1

An embodiment of asphalt stabilized material 14 can include 30% of a first aggregate 10a and 70% of a second aggregate 10b. The first aggregate 10a can include drill cuttings. The drill cuttings can include a high level of volatile hydrocarbon fractions. The second aggregate 10b can include raw base. The asphalt stabilized material 14 can include an emulsion agent 12a without an asphaltene agent 12c. This may generate asphalt stabilized material 14 exhibiting a UCS of approximately 75 psi.

### Example 2

An embodiment of asphalt stabilized material 14 can include 30% of a first aggregate 10a and 70% of a second aggregate 10b. The first aggregate 10a can include drill cuttings. The drill cuttings can include a high level of volatile hydrocarbon fractions. The second aggregate 10b can include raw base. The asphalt stabilized material 14 can include an emulsion agent 12a and an asphaltene agent 12c. The asphaltene agent 12c can include gilsonite. This may generate asphalt stabilized material 14 exhibiting a UCS of approximately 45 psi.

### Example 3

An embodiment of asphalt stabilized material 14 can include 40% of a first aggregate 10a and 60% of a second aggregate 10b. The first aggregate 10a can include drill cuttings. The drill cuttings can include a high level of volatile hydrocarbon fractions. The second aggregate 10b can include raw base. The asphalt stabilized material 14 can include an emulsion agent 10a without an asphaltene agent 10c. This may generate asphalt stabilized material 14 exhibiting a UCS of approximately 45 psi.

### Example 4

An embodiment of asphalt stabilized material 14 can include 40% of a first aggregate 10a and 60% of a second aggregate 10b. The first aggregate 10a can include drill cuttings. The drill cuttings can include a high level of volatile hydrocarbon fractions. The second aggregate 10b can include raw base. The asphalt stabilized material 14 can include an emulsion agent 12a and an asphaltene agent 12c. The asphaltene agent 12c can include gilsonite. This may generate asphalt stabilized material 14 exhibiting a UCS of approximately 50 psi.

Examples 3 and 4 demonstrate that the addition of an asphaltene agent 12c can increase the UCS of asphalt stabilized material 14 comprising a high level of volatile hydrocarbon fractions.

Embodiments of the asphalt stabilized material 14 can include various ratios of first aggregate 10a and second aggregate 10b. The amount of first aggregate 10a may be changed, depending on the amount/concentration of toxin and/or volatile hydrocarbon fractions. For example, an embodiment of asphalt stabilized material 14 may include 30% of a first aggregate 10a and 70% of a second aggregate 10b. The first aggregate 10a can include drill cuttings with a leachable toxin (e.g., chloride) level at or below 9,500 mg/kg. The drill cuttings 10a may also include volatile hydrocarbon fractions. The second aggregate 10b can include virgin base material. The asphalt stabilized material 14 can include a 2.25% maltene-modified emulsion agent. This may generate asphalt stabilized material 14 with an acceptable level of leachable toxin and a suitable level of stability. If the leachable toxin in the drill cuttings 10a was at or below 8,500 mg/kg, then the first aggregate 10a to second aggregate 10b ratio can be changed. For example, if the leachable toxin in the drill cuttings 10a was at or below 8,500 mg/kg, the asphalt stabilized material 14 can include 40% of the first aggregate 10a, 60% of the second aggregate 10b, and 2.25% of the maltene-modified emulsion agent. If the increase in first aggregate 10a causes the UCS of the asphalt stabilized material 14 to fall below a suitable level (due to the increased amount/concentration of volatile hydrocarbon fractions present in the asphalt stabilized material 14), then an asphaltene agent 12c can be added to increase the UCS.

Some first aggregate 10a to second aggregate 10 ratios can also depend on the quality and composition of the second aggregate 10b.

It should be understood that modifications to the embodiments disclosed herein can be made to meet a particular set of design criteria. For instance, the amount/concentration or type of first aggregates 10a, second aggregates 10b, emulsion agents 12a, maltene agents 12b, asphaltene agents 12c, ingredients 16, etc. can be any suitable amount/concentration or type of each to meet a particular objective. Therefore, while certain exemplary embodiments of the asphalt stabilized material 14 and methods of producing the same disclosed herein have been discussed and illustrated, it is to be distinctly understood that the invention is not limited thereto but may be otherwise variously embodied and practiced within the scope of the following claims.

It will be apparent to those skilled in the art that numerous modifications and variations of the described examples and embodiments are possible in light of the above teachings of the disclosure. The disclosed examples and embodiments are presented for purposes of illustration only. Other alternate embodiments may include some or all of the features disclosed herein. Therefore, it is the intent to cover all such modifications and alternate embodiments as may come within the true scope of this invention, which is to be given the full breadth thereof. Additionally, the disclosure of a range of values is a disclosure of every numerical value within that range, including the end points.

What is claimed is:

1. A conditioned material, comprising:
an unconditioned material comprising one or more toxin and/or one or more volatile hydrocarbon fraction;
a first additive configured to encapsulate the one or more toxin; and
a second additive configured to absorb the one or more volatile hydrocarbon fraction.

2. The conditioned material recited in claim 1, wherein the first additive is configured to encapsulate a predetermined amount of the one or more toxin.

3. The conditioned material recited in claim 1, wherein the second additive is configured to absorb a predetermined amount of the one or more volatile hydrocarbon fraction.

4. The conditioned material recited in claim 1, wherein the encapsulation prevents and/or inhibits leaching of the one or more toxin from the conditioned material to a surrounding environment.

5. The conditioned material recited in claim 1, wherein the unconditioned material is drill cuttings.

6. The conditioned material recited in claim 1, wherein the conditioned material is roadway material and/or aggregate for the roadway material.

7. Roadway material, comprising:
aggregate comprising one or more toxin and/or one or more volatile hydrocarbon fraction;
a first additive configured to encapsulate a predetermined amount of the one or more toxin; and
a second additive configured to absorb a predetermined amount of the one or more volatile hydrocarbon fraction.

8. The roadway material recited in claim 7, wherein the aggregate comprises a first aggregate and a second aggregate.

9. The roadway material recited in claim 8, wherein the first aggregate comprises drill cuttings and the second aggregate comprises gravel, sand, crushed or pulverized cement, and/or recycled pavement.

10. The roadway material recited in claim 7, wherein the first additive is further configured to facilitate suspension of a predetermined amount of a globule of asphalt cement.

11. The roadway material recited in claim 10, further comprising a third additive configured to reduce the amount of the first additive to achieve the predetermined level of stability for the roadway material.

12. The roadway material recited in claim 7, wherein the roadway material has a Unconfined Compressive Strength of at least 35 pounds per square inch.

13. The roadway material recited in claim 7, wherein the roadway material comprises at least one of arsenic, barium, cadmium, chromium, lead, mercury, selenium, silver, zinc, benzene, chlorides, and/or total petroleum hydrocarbons.

14. The roadway material recited in claim 7, wherein the roadway material has high levels of volatile hydrocarbon fractions.

15. Roadway material, comprising:
a first aggregate comprising one or more toxin and one or more volatile hydrocarbon fraction;
a second aggregate comprising roadway material;
a first additive configured to encapsulate a predetermined amount of the one or more toxin and to facilitate suspension of a predetermined amount of a globule of asphalt cement; and
a second additive configured to reduce the amount of the first additive to achieve the predetermined level of stability for the roadway material.

16. The roadway material recited in claim 15, further comprising a third additive configured to absorb a predetermined amount of the one or more volatile hydrocarbon fraction.

17. The roadway material recited in claim 15, wherein the roadway material comprises:
0% to 100% first aggregate;
0% to 100% second aggregate;
above 0.0% to 5.0% first additive, wherein the percent is a weight percent of the mixture of first aggregate and second aggregate; and
above 0.0% to 20.0% second additive, wherein the percent is a weight percent of the mixture of first aggregate and second aggregate.

18. The roadway material recited in claim 16, wherein the roadway material comprises:
0% to 100% first aggregate;
0% to 100% second aggregate;
above 0.0% to 5.0% first additive, wherein the percent is a weight percent of the mixture of first aggregate and second aggregate;
above 0.0% to 20.0% second additive, wherein the percent is a weight percent of the mixture of first aggregate and second aggregate; and
above 0.00% to 20.0% third additive, wherein the percent is a weight percent of the mixture of first aggregate and second aggregate.

19. The roadway material recited in claim 18, wherein:
the roadway material has a Unconfined Compressive Strength of at least 35 pounds per square inch;
the roadway material comprises at least one of arsenic, barium, cadmium, chromium, lead, mercury, selenium, silver, zinc, benzene, chlorides, and total petroleum hydrocarbons; and
the roadway material has high levels of volatile hydrocarbon fractions.

20. A method of processing drill cuttings, comprising:
adding an additive to the drill cuttings to at least one of:
encapsulate a predetermined amount of one or more toxin that is part of the drill cuttings; and
absorb a predetermined amount of one or more volatile hydrocarbon fraction that is part of the drill cuttings.
